(19) United States
(12) Patent Application Publication
(10) Pub. No.: US 2023/0407096 A1
(43) Pub. Date: Dec. 21, 2023

(54) Biodegradable Straw

(71) Applicant: Chien-Chung Huang, Taichung City (TW)

(72) Inventor: Chien-Chung Huang, Taichung City (TW)

(21) Appl. No.: 18/450,679

(22) Filed: Aug. 16, 2023

Related U.S. Application Data
(63) Continuation-in-part of application No. 16/862,477, filed on Apr. 29, 2020.
Application No. 16/862,477 is a continuation-in-part of application No. 16/036,616, filed on Jul. 16, 2018, now abandoned.

(51) Int. Cl. C08L 97/02; A47G 21/18; C08L 67/02

(52) U.S. Cl. CPC C08L 97/02; A47G 21/18; C08L 67/02; C08L 2201/06

(57) ABSTRACT

A biodegradable straw, which includes: a plant acid-modified plant fiber material, accounting for 20 wt % to 70 wt % of a total weight of the biodegradable straw; and a PBS material, accounting for 30 wt % to 80 wt % of the total weight of the biodegradable straw; wherein the plant acid-modified plant fiber material is mixed with the PBS material and then extruded and molded into the biodegradable straw. The biodegradable plant fiber and PBS material serve as raw materials for the straw, and the plant fiber is transformed with plant acid to improve the natural decomposition efficiency of the biodegradable straw in the environment, reduce environmental pollution, meet the demands of environmental protection, and improve the food safety of the biodegradable straw. It also improves the economic benefit of the biodegradable straw and reduces the production cost.

### CROSS REFERENCE TO RELATED APPLICATION

This application is a continuation in part of U.S. patent application Ser. No. 16/862,477, which is a continuation in part of U.S. patent application Ser. No. 16/036,616, and claims the earliest filing date of Jul. 16, 2018, the entire specifications of which are incorporated herein by reference.

### BACKGROUND

### Field of the Invention

The present invention relates to a straw, and more particularly to a straw made of biodegradable materials.

### Description of Related Art

The straws on the market are mainly divided into three types: plastic, glass, and stainless steel. Plastic straws are made of petroleum refined ingredients, which are easy to release toxic plasticizers when exposed to high temperatures or acidic drinks. For stores that often sell beverages with rich fruit acids, the use of plastic straws poses a higher risk of toxicity. On the other hand, glass straws are mainly made of silica and require a high temperature of 1600° C. to be manufactured. However, the hardness of glass is high and it is easy to break in sudden situations. The energy consumption for the manufacturing process of the stainless steel straws is enormous, requiring a high temperature of 1500° C., and emitting a large amount of exhaust gas and heat throughout the entire process. Whether it is glass or stainless steel, from raw materials to products, they consume a lot of earth resources, while aggravating the greenhouse effect. In addition, the plasticizer of plastic straws will dissolve when it is exposed to high temperature or ester-containing drinks, which may lead to sexual precocity, infertility, and other problems if accumulated in the human body for a long time, and also easily cause asthma and allergies, so its use safety is questionable.

It is worth noting that as daily tableware, straws need to ensure their physical, chemical, and other properties to satisfy user needs and be environmentally friendliness. First of all, the straw should have good temperature resistance and chemical stability, so that it can maintain structural stability when in contact with hot or cold drinks, and does not produce chemical reactions with the drink or release substances that have an impact on the taste or safety of the drink. Secondly, strength and toughness are also necessary. The straw should be able to withstand the pressure and bending during use and restore its original state after pressure relief.

Moreover, from a critical food safety perspective, straws should be made from food-grade materials without harmful substances like plasticizers or heavy metals. In consideration of environmental protection, the material of the straw should be biodegradable to reduce the impact on the environment. In addition, straws need appropriate hardness and surface smoothness to ensure comfortable use, while taking into account economic benefits and production costs. These are important considerations when choosing straw materials and processes.

Therefore, the inventor believes it is essential to propose a biodegradable straw that meets the above requirements.

### SUMMARY

Considering the above technical issues and the requirements for straw products, the objective of the present invention is to improve the efficiency of the natural decomposition of straws in the environment, reduce environmental pollution, and achieve environmental protection demands.

Another objective of the present invention is to improve the food safety of straws.

The further objective of the present invention is to improve the economic efficiency of the straws and reduce production costs.

To achieve the aforementioned objectives, the present invention provides a biodegradable straw, which includes: a plant acid-modified plant fiber material, accounting for 20 wt % to 70 wt % of a total weight of the biodegradable straw; and a PBS material, accounting for 30 wt % to 80 wt % of the total weight of the biodegradable straw; wherein the plant acid-modified plant fiber material is mixed with the PBS material and then extruded to form the biodegradable straw.

Therefore, the present invention uses the plant acid-modified plant fiber material and the biodegradable PBS material as raw materials of the straw to improve the natural decomposition efficiency of the straw in the environment and meet environmental requirements. The present invention uses plant acid-modified plant fiber material and PBS material to mix and produce straws, which has the advantage of being natural, thereby enhancing the food safety of straws. Additionally, this enhances the heat deformation temperature of the produced straw products, giving the biodegradable straws of the present invention a commendable heat resistance that's advantageous for transportation and prolongs storage time. This not only ensures food safety for consumers but also facilitates businesses in stocking the straws. Furthermore, the straw made by mixing plant acid-modified plant fiber material with PBS material in the present invention demonstrates a notable increase in both tensile strength and impact strength. In addition to being beneficial for the processing and widespread application of the biodegradable straw of the present invention, it also improves the processing and production efficiency of the straw, thereby reducing production costs and meeting economic benefits.

In one of the embodiments of the present invention, the plant acid can be selected from the group consisting of lactic acid, tartaric acid, and citric acid.

In one of the embodiments of the present invention, the plant fiber material can be selected from the group consisting of sugarcane fiber, bamboo fiber, coir, palm shell fiber, used coffee grounds, wine dregs, wheat dregs, cotton, hemp fiber, rice straw, rice husk, corn straw, starch, wood flour and a combination thereof.

In one embodiment of the present invention, the PBS material can account for 30 wt % to 50 wt % of the total weight of the biodegradable straw.

In one embodiment of the present invention, the weight ratio of the plant acid to the plant fiber in the plant acid-modified plant fiber material can be 1:7 to 1:10.

In one of the embodiments of the present invention, the plant acid-modified plant fiber material can be plant acid-modified sugarcane fiber, which can account for 55 wt % to 65 wt % of the total weight of the biodegradable straw, and the PBS material can account for 35 wt % to 45 wt % of the total weight of the biodegradable straw. Preferably, in one of the embodiments of the present invention, the weight ratio of the plant acid to the plant fiber in the plant acid-modified plant fiber material can be 1:9.

Preferably, the plant acid-modified plant fiber material can account for 20 wt %, 25 wt %, 30 wt %, 35 wt %, 40 wt %, 45 wt %, 50 wt %, 55 wt %, 60 wt %, 65 wt %, or 70 wt % of the total weight of the biodegradable straw. The weight percentage of the plant acid-modified plant fiber material in the total weight of the biodegradable straw can be within a range defined by any two of the values mentioned above, but it is not limited to this.

Preferably, the PBS material can account for 30 wt %, 35 wt %, 40 wt %, 45 wt %, 50 wt %, 55 wt %, 60 wt %, 65 wt %, 70 wt %, 75 wt %, or 80 wt % of the total weight of the biodegradable straw. The weight percentage of the PBS material in the total weight of the biodegradable straw can be within a range defined by any two of the values mentioned above, but it is not limited to this.

Preferably, in the plant acid-modified plant fiber material, the weight ratio of the plant acid to the plant fiber can be 1:7, 1:8, 1:9, or 1:10. The weight ratio of the plant acid to the plant fiber can be within a range defined by any two of the values mentioned above, but it is not limited to this.

In one of the embodiments of the present invention, the biodegradable straw has a tensile strength of 420 MPa to 750 MPa, which is defined according to the standard method specified in ASTM D-638 (⅛″, 23° C.).

Preferably, the tensile strength of the biodegradable straw can be 420 MPa, 440 MPa, 460 MPa, 480 MPa, 500 MPa, 520 MPa, 540 MPa, 560 MPa, 580 MPa, 600 MPa, 620 MPa, 640 MPa, 660 MPa, 680 MPa, 700 MPa, 720 MPa, or 740 MPa. The tensile strength of the biodegradable straw can be within a range defined by any two of the values mentioned above, but it is not limited to this.

In one of the embodiments of the present invention, the biodegradable straw has an impact strength of 3.5 kJ/m² to 9.5 kJ/m², which is defined according to the standard method specified in ASTM D-256.

Preferably, the impact strength of the biodegradable straw can be 3.5 kJ/m², 4.0 kJ/m², 4.5 kJ/m², 5.0 kJ/m², 5.5 kJ/m², 6.0 kJ/m², 6.5 kJ/m², 7.0 kJ/m², 7.5 kJ/m², 8.0 kJ/m², 8.5 kJ/m², 9.0 kJ/m², or 9.5 kJ/m². The impact strength of the biodegradable straw can be within a range defined by any two of the values mentioned above, but it is not limited to this.

In one of the embodiments of the present invention, the biodegradable straw has a heat deformation temperature (HDT) of 105° C. to 135° C., which is defined according to the standard method specified in ASTM D648 (4.6 kg/cm²).

Preferably, the heat deformation temperature of the biodegradable straw can be 105° C., 110° C., 115° C., 120° C., 125° C., 130° C., or 135° C. The heat deformation temperature of the biodegradable straw can be within a range defined by any two of the values mentioned above, but it is not limited to this.

In one of the embodiments of the present invention, the thickness of the biodegradable straw can be 80 μm to 800 μm. Preferably, the thickness of the biodegradable straw in the present invention can be 100 μm to 300 μm.

The present invention also provides a method for producing a biodegradable straw as mentioned above, which includes the following steps:

Step 1: mixing plant fiber, and plant acid (for example: lactic acid, tartaric acid, or citric acid) with water at a weight ratio of 9:1:30, and heat and stir uniformly at 100° C. for 2 hours to prepare the plant acid-modified plant fiber material. In this step, preferably, the proportion of the water added is three times the total weight of the plant fiber and the plant acid.

Step 2: mixing the plant acid-modified plant fiber material with PBS material to form an unformed biodegradable material; in this step, preferably, the process of mixing the plant acid-modified plant fiber material and the PBS material is based on the following temperature sequence: 140° C.→160° C.→180° C.→180° C.→180° C.→180° C.→180° C.→170° C.→160° C.→150° C., and the mixing temperature is instantly switched within the range from 140° C. to 180° C.

Step 3: molding the unformed biodegradable material obtained in Step 2 to produce the biodegradable straw of the present invention; in this step, preferably, the process for molding the unformed biodegradable material is based on the following temperature sequence: 140° C.→160° C.→180° C.→200° C.→180° C.→150° C., and the molding temperature is instantly switched within a range from 140° C. to 200° C.

In one of the embodiments of the present invention, the plant fiber can be selected from upright fibers or cotton-fluff-like plant fibers, which are then pretreated to form a powder and mixed into biodegradable plastic. Preferably, the pre-treatment method for plant fiber includes drying the obtained plant fiber and grinding it with a grinder to a predetermined material powder fineness to obtain plant fiber suitable for blending into biodegradable plastic (PBS material). In the aforementioned pre-treatment step, depending on the size of the feeding port of the grinder, the dried plant fiber is cut to an appropriate size before being put into the grinder.

The above sequence of steps is not limited to the manufacturing method of the biodegradable straw of the invention and can be adjusted according to actual operational needs. Among them, the plant fiber material can also include a plant fiber pretreatment step before step 1, in order to increase the mutual fusion effect between plant fibers and biodegradable plastics. Among them, step 2 involves mixing plant acid-modified plant fiber material with PBS material according to the specific proportion mentioned above to prepare an unformed biodegradable material suitable for processing into straws. The specific processing steps can include metering, blending, stirring, plasticizing, molding, pelletizing, and packaging.

As for the techniques, means, and other effects of this invention to achieve the above objectives, the best feasible embodiments are listed below and illustrated in detail with the drawings.

### DETAILED DESCRIPTION

In order to facilitate the understanding of this invention, the following embodiments will be used to illustrate.

Some embodiments of the features and advantages of this invention will be described in detail in the following explanations. It should be understood that this invention can have various variations, but they are all within the scope of the invention, and the specification and drawings therein are used as instructions in nature, not to limit the invention.

This invention provides a biodegradable straw, which is made of plant acid-modified plant fiber material and biodegradable PBS material. In the plant acid-modified plant fiber material, the plant fiber is selected from the group consisting of sugarcane fiber, bamboo fiber, coir, palm shell fiber, used coffee grounds, wine dregs, wheat dregs, cotton, hemp fiber, rice straw, rice husk, corn straw, starch, wood flour or a combination thereof. The plant acid in the plant acid-modified plant fiber material is selected from lactic acid, tartaric acid or citric acid. In this embodiment, the composition ratio of the biodegradable straw includes a plant acid-modified plant fiber material that accounts for 20 wt % to 70 wt % of its total weight, as well as the PBS material that accounts for 30 wt % to 80 wt % of its total weight. The plant acid-modified plant fiber material is mixed with the PBS material and then molded into the biodegradable straw.

This invention provides a method for producing the biodegradable straw as described above, which includes the following steps:
Step 1: mixing sugarcane fiber, and plant acid (lactic acid, tartaric acid, or citric acid) with water at a weight ratio of 9:1:30, and heat and stir uniformly at 100° C. for 2 hours to prepare the plant acid-modified plant fiber material.
Step 2: mixing the plant acid-modified plant fiber material with the PBS material to form an unformed biodegradable material; wherein the process of mixing the plant acid-modified plant fiber material and the PBS material is based on the following temperature sequence: 140° C.→160° C.→180° C.→180° C.→180° C.→180° C.→180° C.→170° C.→160° C.→150° C., and the mixing temperature is instantaneously switched within the range from 140° C. to 180° C.
Step 3: molding the unformed biodegradable material obtained in Step 2 into a biodegradable straw; wherein the process for molding the unformed biodegradable material is based on the following temperature sequence: 140° C.→160° C.→180° C.→200° C.→180° C.→150° C., and the molding temperature is instantaneously switched within a range from 140° C. to 200° C.

Table 1 below shows Examples E1 to E5 of the present invention and Comparison Examples C1 to C3 using the aforementioned biodegradable straw manufacturing method and different raw material ratios in the present invention. Among them, the difference between the manufacturing method of the Comparison Examples and the Examples is only that the Comparison Examples do not include step 1, and in step 2, unmodified plant fiber (sugarcane fiber) and PBS material are mixed under the same parameter conditions, and then in step 3, the mixed material is subjected to molding process using the same parameter conditions.

TABLE 1
Composition and ratio of raw materials for Examples
E1 to E5 and Comparison Examples C1 to C3.

| | | PBS | Plant acid (wt %) | | Sugarcane |
|---|---|---|---|---|---|
| Sample to be tested | | (wt %) | Type | Ratio | fiber (wt %) |
| Examples | E1 | 40 | Lactic acid | 6 | 54 |
| | E2 | 40 | Tartaric acid | 6 | 54 |
| | E3 | 40 | Citric acid | 6 | 54 |
| | E4 | 80 | Lactic acid | 2 | 18 |
| | E5 | 60 | Lactic acid | 4 | 36 |

| | | | | |
|---|---|---|---|---|
| Comparison | C1 | 80 | N.A. | 20 |
| Examples | C2 | 60 | N.A. | 40 |
| | C3 | 40 | N.A. | 60 |

(N.A.: Refers to the absence of added plant acid)

TABLE 2
The tensile strength, impact strength, and HDT test results
of Examples E1 to E5 and Comparison Examples C1 to C3.

| | | | Impact | |
|---|---|---|---|---|
| | | Tensile strength | strength | HDT |
| Sample to be tested | | (kg/cm²(MPa)) | (kJ/m²) | (° C.) |
| Examples | E1 | 747.6 | 5.4 | 132 |
| | E2 | 693.4 | 5.1 | 130 |
| | E3 | 678.5 | 3.9 | 117 |
| | E4 | 426.3 | 9.1 | 108 |
| | E5 | 611.4 | 6.5 | 123 |
| Comparison | C1 | 311.2 | 4.5 | 101 |
| Examples | C2 | 305.6 | 3.2 | 113 |
| | C3 | 232.1 | 1.4 | 118 |

As shown in Table 1 and Table 2, by comparing Examples E1 to E3, under the condition that the PBS material accounts for 60 wt % of the total weight of the biodegradable straw, and the ratio of the plant acid and the plant fiber is the same (1:9), Example E1 (lactic acid) has better tensile strength, impact strength and heat deformation temperature than Example E2 (tartaric acid) and Example E3 (citric acid). Furthermore, comparing Examples E1 to E5 with Comparison Examples C1 to C3, it can be seen that Examples E1 to E5 with the addition of plant acid-modified plant fiber material have much better tensile strength, impact strength, and heat deformation temperature than Comparison Examples C1 to C3 with the addition of unmodified plant fibers, thus proving that the fibers treated with plant acid have become reinforcing materials, rather than general fibers (used as fillers) for cost reduction.

According to the compost plastic product validation plan jointly established by the International Biodegradable Products Institute (BPI) and the United States Composting Council (USCC), under the condition of meeting the standard D6400 specified by the American Society for Testing and Materials (ASTM), namely, a humidity of 50%, a temperature of approximately 60° C. and sufficient oxygen conditions, the biodegradable straw of the invention can decompose more than 90% within 180 days. Furthermore, under the condition of meeting the standard EN13432 of ASTM, i.e. humidity of 50%, temperature of about 25±5° C., and sufficient oxygen, the biodegradable straw of the invention can decompose more than 90% within 360 days. Thus, it can indeed reduce environmental pollution, offering a biodegradable straw that aligns with environmental conservation needs.

In summary, the present invention employs biodegradable plant fiber and PBS material as straw raw material for the straw, with the plant fiber being pre-modified with plant acid before being mixed with PBS material and then extruded to form a biodegradable straw. It does indeed improve the tensile strength, impact strength, and heat deformation temperature of the straw product. The present invention not only enhances the processability, broad applicability, processing efficiency, heat resistance, and storage time of the straw products but also helps in reducing production costs. This aligns with both green environmental protection standards and offers economic benefits.

The above embodiments are only examples for convenience of explanation, but they are not intended to limit the scope of the claims of this invention. All other changes, variations, and other modifications that are not contrary to the disclosure of this invention shall be included in the scope of the patent covered by this invention.

What is claimed is:

1. A biodegradable straw, comprising:
a plant acid-modified plant fiber material, accounting for 20 wt % to 70 wt % of a total weight of the biodegradable straw; and
a PBS material, accounting for 30 wt % to 80 wt % of the total weight of the biodegradable straw; wherein the plant acid-modified plant fiber material is mixed with the PBS material and then extruded to form the biodegradable straw.

2. The biodegradable straw as claimed in claim 1, wherein the plant acid is selected from the group consisting of lactic acid, tartaric acid and citric acid.

3. The biodegradable straw as claimed in claim 1, wherein the plant fiber material is selected from the group consisting of sugarcane fiber, bamboo fiber, coir, palm shell fiber, used coffee grounds, wine dregs, wheat dregs, cotton, hemp fiber, rice straw, rice husk, corn straw, starch, wood flour and a combination thereof.

4. The biodegradable straw as claimed in claim 1, wherein the PBS material accounts for 30 wt % to 50 wt % of the total weight of the biodegradable straw.

5. The biodegradable straw as claimed in claim 1, wherein a weight ratio of the plant acid to the plant fiber in the plant acid-modified plant fiber material is 1:7 to 1:10.

6. The biodegradable straw as claimed in claim 1, wherein the plant acid-modified plant fiber material is plant acid modified sugarcane fiber, which accounts for 55 wt % to 65 wt % of the total weight of the biodegradable straw, and the PBS material accounts for 35 wt % to 45 wt % of the total weight of the biodegradable straw.

7. The biodegradable straw as claimed in claim 6, wherein the weight ratio of the plant acid to the plant fiber in the plant acid-modified plant fiber material is 1:9.

8. The biodegradable straw as claimed in claim 1 has a tensile strength of 420 MPa to 750 MPa, which is defined according to a standard method specified in ASTM D-638.

9. The biodegradable straw as claimed in claim 2 has a tensile strength of 420 MPa to 750 MPa, which is defined according to a standard method specified in ASTM D-638.

10. The biodegradable straw as claimed in claim 4 has a tensile strength of 420 MPa to 750 MPa, which is defined according to a standard method specified in ASTM D-638.

11. The biodegradable straw as claimed in claim 5 has a tensile strength of 420 MPa to 750 MPa, which is defined according to a standard method specified in ASTM D-638.

12. The biodegradable straw as claimed in claim 1 has an impact strength of 3.5 kJ/m² to 9.5 kJ/m², which is defined according to a standard method specified in ASTM D-256.

13. The biodegradable straw as claimed in claim 2 has an impact strength of 3.5 kJ/m² to 9.5 kJ/m², which is defined according to a standard method specified in ASTM D-256.

14. The biodegradable straw as claimed in claim 4 has an impact strength of 3.5 kJ/m² to 9.5 kJ/m², which is defined according to a standard method specified in ASTM D-256.

15. The biodegradable straw as claimed in claim 5 has an impact strength of 3.5 kJ/m² to 9.5 kJ/m², which is defined according to a standard method specified in ASTM D-256.

16. The biodegradable straw as claimed in claim 1 has a heat deformation temperature of 105° C. to 135° C., which is defined according to a standard method specified in ASTM D648.

17. The biodegradable straw as claimed in claim 2 has a heat deformation temperature of 105° C. to 135° C., which is defined according to a standard method specified in ASTM D648.

18. The biodegradable straw as claimed in claim 4 has a heat deformation temperature of 105° C. to 135° C., which is defined according to a standard method specified in ASTM D648.

19. The biodegradable straw as claimed in claim 5 has a heat deformation temperature of 105° C. to 135° C., which is defined according to a standard method specified in ASTM D648.
